(19) United States
(12) Patent Application Publication
(10) Pub. No.: US 2005/0089295 A1
(43) Pub. Date: Apr. 28, 2005

(54) Adjustable optical attenuator using S-type wave-guide and method thereof

(76) Inventors: Huang-Chen Guo, Hsinchu (TW); Ying-Tsung Lu, Hsinchu (TW)

Correspondence Address: BIRCH STEWART KOLASCH & BIRCH, PO BOX 747, FALLS CHURCH, VA, 22040-0747, US

(21) Appl. No.: 10/823,578

(22) Filed: Apr. 14, 2004

(30) Foreign Application Priority Data
Oct. 24, 2003 (TW) 092129666

(51) Int. Cl. G02B 6/00

(52) U.S. Cl. 385/140

(57) ABSTRACT

An adjustable optical attenuator using S-type wave-guide comprises a cladding layer having a first refraction index and forming a slot therein; and a core layer embedded in the slot of the cladding layer and having a second refraction index sensitive to temperature change, wherein light is transmitted through the core layer, and light attenuation varies according to the temperature of the core layer.

### BACKGROUND OF THE INVENTION

1. Field of Invention

The present invention relates to optical attenuators, and more particularly to an optical attenuator using S-type wave-guide bending and refraction index variation to obtain a greater range of power attenuation.

2. Related Art

An optical attenuator is conventionally used to attenuate the light power,- and constitute an important passive element in the field of optical engineering, especially in optical fiber system indicators and meters, signal attenuators of short-distance communication systems, etc.

Optical attenuators conventionally work in two ways. In a first mode of operation, longitudinal or transversal displacement is used to misalign the optical fiber and thereby achieve light attenuation. In a second mode of operation, a glass element with light absorption characteristics is introduced in the light path. The optical attenuator can be divided into a fixed type attenuator, gradually adaptable attenuator, or continuously adjustable attenuator.

Most of the optical attenuators currently implement optical system techniques or optical finer structure techniques, though another type of attenuator known of the art may use optical wave-guide technique. Optical fiber attenuators are often used in optical fiber communication systems, and attenuation usually is achieved via optical fiber bending, shift, pressing, changing the refraction index, etc.

Conventionally, optical attenuators that use optical system techniques and optical fiber techniques have a size that is larger than attenuators that use optical wave-guide techniques. Further, a optical attenuator constructed with optical system techniques has a simpler structure and low production costs. However, the latter, having an attenuation adjustment, is more difficult to achieve than the optical attenuator constructed according to optical wave-guide techniques.

In other words, optical system techniques and optical fiber techniques have the disadvantages of forming optical attenuators of excessively large dimensions, high production costs, and difficulties in adjustment. In recent technical developments, a particular emphasis has been made on attenuators constructed with a optical wave-guide structure.

U.S. Pat. No. 6,385,383 discloses an optical attenuator constructed with a optical wave-guide structure, and particularly a linear wave-guide structure. The linear wave-guide structure has two locations cladding different materials. This type of attenuator structure is formed embedded, which may render the fabrication process more difficult to achieve and be subjected to adverse reflection. Further, the temperature adjustment range has to reach 180° C., which can cause instability. In addition, the core wave-guide of the attenuator structure is enclosed in a cladding layer, which renders the fabrication process more complex.

U.S. Patent Application Publication No. 2003/0016937A1 discloses an arc-profiled wave-guide structure. However, the wave-guide section still is embedded, which renders the fabrication process difficult and further requires a temperature adjustment range of at least 90° C. This type of structure further cannot be easily integrated due to non-parallelism between its light outlet direction and its light inlet direction.

In the current technical trend, the principal criteria of performance for the optical attenuators include factors such as lightweight, small size, high precision, good stability, convenient adjustment, low costs, and simple manufacturing. In respect of these criteria, improvement of the current optical attenuator is needed.

### SUMMARY OF THE INVENTION

According to an aspect of the invention, an S-type wave-guide optical attenuator has a simple structure, simple and low-cost manufacturing process, small size, and is easy to adjust.

According to another aspect of the invention, the S-type wave-guide optical attenuator has an S-type wave-guide and an embedded section structure to adjust the temperature variation, and is applicable in optical communication elements and optical wave-guide integrated elements.

In one embodiment, an S-type wave-guide adjustable optical attenuator comprises a cladding layer having a first refraction index and a slot formed therein. Further, a core layer embedded in the slot of the cladding layer having a second refraction index sensitive to temperature change, wherein light is transmitted through the core layer. Light attenuation varies according to the temperature of the core layer.

In another embodiment, an S-type wave-guide attenuating method comprises transmitting light through a optical attenuator, wherein the optical attenuator includes a cladding layer and a core layer made of a polymer material and embedded in a slot of the cladding layer. The core layer has a temperature-sensitive refraction index, and controls the temperature of the core layer to obtain an attenuation of the light emerging out of the optical attenuator.

Compared to the prior art, the optical attenuator has a temperature adjustment range that can be controlled within 30° C., and thus is less subjected to aging due to high temperature variations. Further, light attenuation can be more easily controlled, and the optical attenuator has a uniform direction with the serial connection of the integrated element, which facilitates its integration.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given in the illustration below only, and is thus not limitative of the present invention, wherein:

FIG. 1 is a schematic view of an S-type wave-guide optical attenuator according to an embodiment of the invention;

FIG. 2 is a schematic view of an S-type wave-guide;

FIG. 3 is a graph describing the relationship between the light wavelength (1.3 μm˜1.35 μm) and the transmission loss in different temperature variation;

FIG. 4 is a graph describing a relationship between the light wavelength (1.5 μm˜1.56 μm) and the transmission loss in different temperature variation;

FIG. 5 is a graph describing the relationship between the wavelength (1.28 μm and 1.33 μm) and corresponding TE and TM fields; and

FIG. 6 is a graph describing the relationship between the wavelength (1.51 μm and 1.56 μm) and corresponding TE and TM fields.

### DETAILED DESCRIPTION OF THE INVENTION

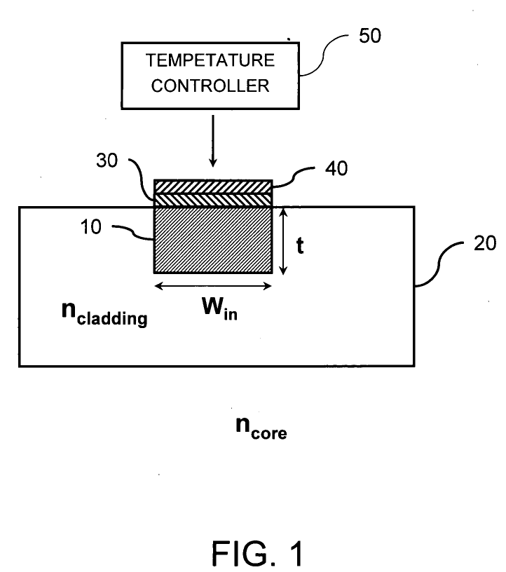

FIG. 1 is a schematic view of a S-type wave-guide optical attenuator according to an embodiment of the invention. The optical attenuator includes a core layer 10, a cladding layer 20, a buffer layer 30, and a temperature-control electrode layer 40. The core layer 10 is embedded in a slot of the cladding layer 20 and exposes a surface over which the buffer layer 30 is placed. The electrode layer 40 is formed on the buffer layer 30. The cladding layer 20 has a first refraction index n_{cladding}, and the core layer 10 has a second refraction index n_{core}.

The core layer 10 is made of a polymer material, and constitutes the principal light guide area. The cladding layer 20 is made of a glass material, and is correspondingly associated with the core layer 10 to obtain an amount of light attenuation. The buffer layer 30 is formed to match with the electrode layer 40, and is made of silicon dioxide SiO₂.

When a temperature controller 50 applies a temperature change via the electrode layer 40 to the core layer 10, the refraction index n_{core} of the core layer 10 will vary accordingly.

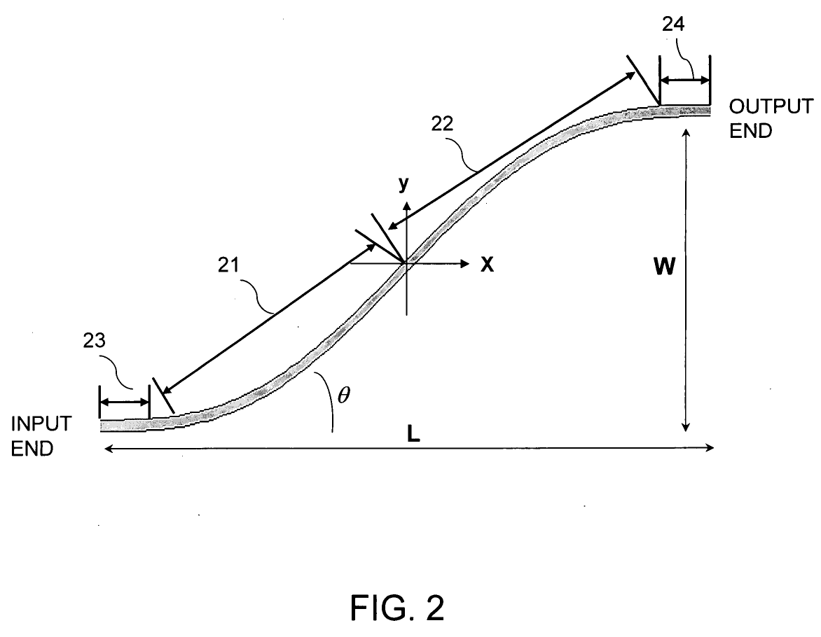

The width Wᵢₙ and the thickness t of the core layer 10 are specific parameters. As shown in FIG. 2, the S-type wave-guide element includes two curved wave-guide portions 21, 22, linear inlet and outlet wave-guide portions 23, 24. This S-type wave-guide can be simply and conveniently manufactured. Light enters through the core layer 10, travels through the two curved wave-guide portions 21, 22, and emerges out via the outlet wave-guide portion 24.

In a Cartesian coordinate system (x, y), the profile of the S-type wave-guide structure can be expressed as follows:
y(x)=(W/L)x−(W/2π)sin(2πx/L)

The S-type wave-guide structure is so-called ‘due to the sine function in the above equation’. Wave-guide structures of similar profiles can also include cosine function, and the S-type wave-guide structure can be otherwise modified to include two continuously curved portions.

The temperature controller 50 is used to adjust and change, via the electrode layer 40 and the buffer layer 30, the temperature of the core layer 10, and consequently its refraction index n_{core}. The temperature controller can be a hot light heater or cooling machine.

When the temperature controller applies the temperature change to the core layer 10, the latter has the most significant variation in refraction index, the cladding layer 20, due to its constituent material, is mostly not affected by the temperature change. Therefore, the polymer-based core layer is, due to the variation in the refraction index, more sensitive to temperature changes than the glass-based cladding layer. The variation ratio in refraction index between the core layer and the cladding layer can be thereby easily controllable.

When the refraction index of the core layer 10 becomes smaller or equal to the refraction index of the cladding layer 20 due to a temperature change, the light propagation direction changes to avoid the core layer 10. As a result, the light power received at the outlet 24 changes according to the modification in the direction of light propagation, which thereby achieves a light attenuation effect.

Therefore, light power can be changed via temperature adjustment. For example, let's assume a preset temperature adjustment range, for example 30° C. The temperature controller is operated to change the temperature range, so that the variation of refraction index of the core layer 10 is also set in a fixed range. On the basis of a weakly guiding property linked to the refraction index, the refraction index difference between the core layer 10 and the cladding layer 20 is reduced in association with a bending loss, so that the attenuation of the light path can be adjusted.

In contrast to the prior art technique, where the temperature of the cladding layer is controlled to vary the refraction index of a part of the cladding layer or a part of the core layer, the invention implements a temperature variation of the core layer to change the refraction index of the whole core layer. Further, in the prior art technique, either the material of both the cladding layer and core layer is similar, or the cladding layer is made of polymer. In contrast, the core layer in the invention is made of polymer, while the cladding layer is made of a glass material.

In a manufacturing process conducted to fabricate the attenuator structure, a slot is etched in a glass substrate, used as cladding layer. A wave-guide polymer material then is filled in the slot to form the core layer. A buffer layer then is spin-coated on the core layer, and a metallic electrode layer is plated on the buffer layer.

The implementation of optical wave-guide element techniques to fabricate a optical attenuator can provide the advantages of a smaller size and an easy adjustment of the optical attenuator. However, the attenuator structure is more complex, which renders the manufacturing process more difficult, especially when high precision is achieved. Therefore, the optical wave-guide attenuator of the invention modifies the structure of the core layer and cladding layer. Further, it uses wave-guide bending and refraction index variation to create a scattering effect due to bending loss occurring during wave guiding and weakly guiding. This is caused by the variation of the refraction index. A significant range of light attenuation can be thereby achieved, while the light wavelength still can keep a certain configuration during transmission. Further, a principal aspect of the invention is that weakly guiding and wave-guide bending effects are implemented via the variation of the refraction index between the core layer and the cladding layer to produce a bending loss, and thereby constitute the attenuation mechanism.

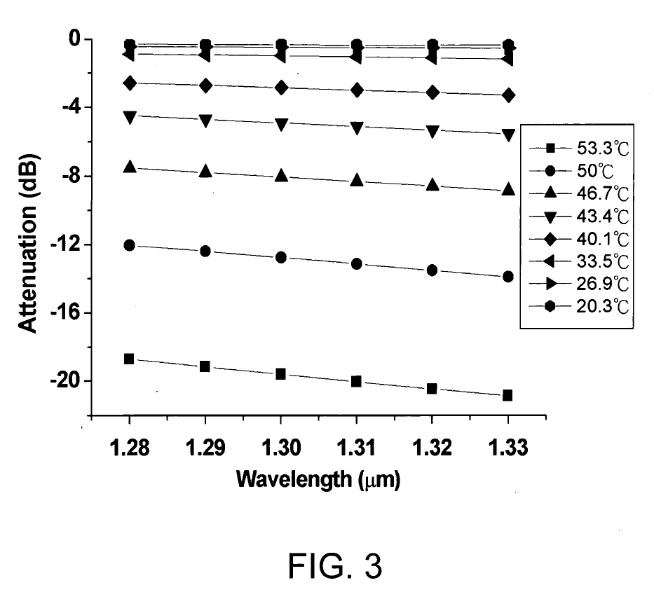

A simulation is conducted to verify the light wave range adequate to the structure of the invention. FIG. 3 is a graph describing a relationship between the light wavelength and the level of attenuation for a temperature adjustment of ΔT=20.3° C.˜50.3° C. For a communication wavelength between 1.28 μm˜1.33 μm, the attenuation level varies between 0 dB˜22 dB according to the temperature adjustment.

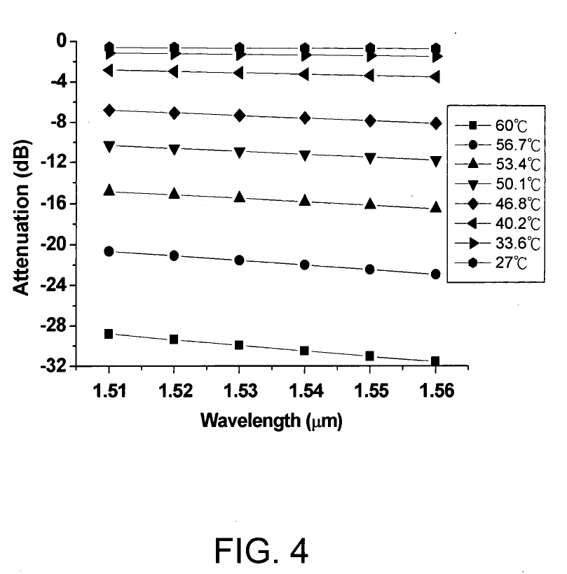

The graph of FIG. 4 shows that, for a communication wavelength between 1.51 μm˜1.56 ∥m, a temperature variation ΔT=27° C.˜60° C. results in a range of light attenuation between 0 dB˜30 dB. FIG. 3 and FIG. 4 therefore show the characteristics of the temperature-controlled optical attenuator, and show that light attenuation can be observed from about 30° C.

The structure of the invention can be also applicable for variations in higher or lower temperature ranges. Because the location of the core layer subjected to refraction index variation is close to the temperature controller, the response time is therefore faster than when the temperature controller is placed on a cladding layer. Light attenuation thereby can be accurately adjusted by modifying the temperature.

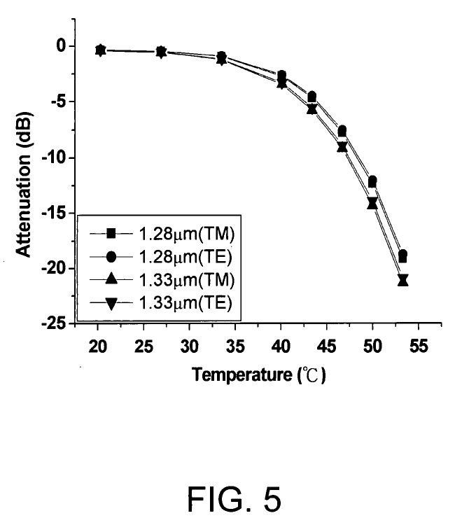

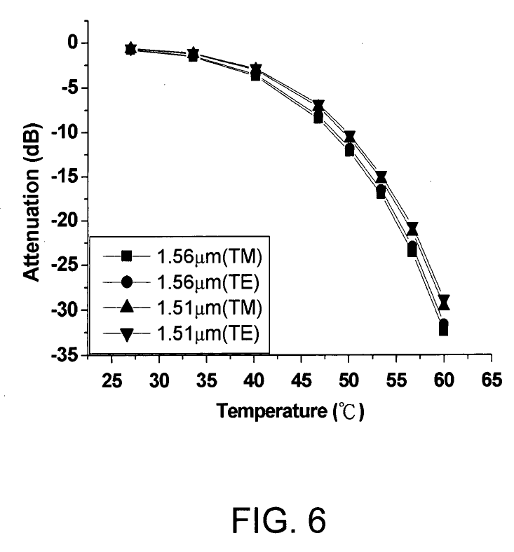

Further, the optical attenuator structure of the invention exhibits good response in respect of polarization effects. As shown in the graphs of FIG. 5 and FIG. 6, for a same wavelength, the wave-guide structure is very little affected by the application of TE, TM fields. For the wavelengths of 1.28 μm and 1.33 μm, the maximal polarization difference (TE and TM) is 0.5 dB (see FIG. 5). For the wavelengths of 1.51 μm and 1.56 μm, the maximal polarization difference is 0.8 dB (see FIG. 6).

The foregoing observations show that the optical attenuator structure of the invention, when undergoing temperature-controlled wave-guide adjustment, exhibits good reliability and stability in respect of light attenuation and polarization variations.

It will be apparent to the person skilled in the art that the invention as described above may be varied in many ways, and notwithstanding remaining within the spirit and scope of the invention as defined in the following claims.

1. A S-type wave-guide adjustable optical attenuator, comprising:
a cladding layer, having a first refraction index and forming a slot therein; and
a core layer, embedded in the slot of the cladding layer and having a second refraction index sensitive to temperature change, wherein the attenuation of an optical signal transmitted through the core layer varies according to the temperature of the core layer.

2. The optical attenuator of claim 1, wherein the core layer is made of a polymer material.

3. The optical attenuator of claim 1, wherein the cladding layer is made of a glass material.

4. The optical attenuator of claim 1, wherein an upper surface of the core layer further includes an electrode layer thereon.

5. The optical attenuator of claim 4, further comprising a buffer layer between the electrode layer and the core layer.

6. The optical attenuator of claim 5, wherein the buffer layer is made of silicon dioxide.

7. The optical attenuator of claim 1, further comprising a temperature controller operable to vary the temperature of the core layer.

8. The optical attenuator of claim 7, wherein the temperature controller further comprises a heater operable to vary the temperature of the core layer.

9. The optical attenuator of claim 7, wherein the temperature controller further comprises a cooling device operable to vary the temperature of the core layer.

10. An optical attenuating method using an S-type wave-guide, comprising:
transmitting an optical signal through an optical attenuator, wherein the optical attenuator includes a cladding layer and a core layer made of a polymer material and embedded in a slot of the cladding layer, the core layer having a temperature-sensitive refraction index; and
controlling the temperature of the core layer to attenuate the intensity of the optical signal.
